(19) United States
(12) Patent Application Publication
(10) Pub. No.: US 2011/0168646 A1
(43) Pub. Date: Jul. 14, 2011

(54) Land Based and Pontoon Based Forced Air Thermal Evaporator

(76) Inventor: James Tafoya, Meeker, CO (US)

(21) Appl. No.: 12/686,210

(22) Filed: Jan. 12, 2010

(51) Int. Cl. C02F 1/04

(52) U.S. Cl. 210/774; 210/180

(57) ABSTRACT

A method of evaporating waste water utilizing waste heat employs a forced air thermal evaporator system having an air heat exchanger with: a waste heat inlet, a waste heat outlet, a cold air inlet and a hot air outlet; a compressor connected with the cold air inlet to force air into the cold air inlet; and a distribution header having a hot air inlet connected with the hot air outlet, a waste water inlet connected to a waste water source, and air/water mixing nozzles connected with the hot air inlet and the waste water inlet. Engaging the compressor forces air through the heat exchanger and into the distribution header where the waste water is admixed with the hot air which then exits through spray nozzles as water vapor.

### BACKGROUND OF THE INVENTION

1. Field of the Invention

The present invention relates generally to evaporation systems and, more specifically, to a water evaporation system for use in disposing of wastewater in the mining, manufacturing, oil and gas and food processing industries. Depicted in the application drawings are dimensioned embodiments for illustrative purposes only of the components of the present invention and should not be taken as the only possible sizes envisioned by the instant invention.

One or more modular nozzle systems float on water source or sit away from water source. For pontoon based system each nozzle system has a series of nozzles that sit on a riser that is attached to inlet air source or for land based has two nozzles mounted on a stand that is attached to inlet air source. Air is pumped through a primary heat exchanger to inlet air distribution header and through nozzles, which draws water into the air/water mixing nozzles to emit small water droplets that are evaporated.

2. Description of the Prior Art

There are other evaporator devices designed for wastewater. Typical of these is U.S. Pat. No. 1,233,119 issued to Parker on Jul. 10, 1917.

Another patent was issued to Horn et al. on May 22, 1984 as U.S. Pat. No. 4,449,849. Yet another U.S. Pat. No. 4,762,276 was issued to Foust on Aug. 9, 1988 and still yet another was issued on Feb. 20, 2001 to Blagborne as U.S. Pat. No. 6,190,498.

Another patent was issued to Schmitt on Oct. 12, 2004 as U.S. Pat. No. 6,802,360. Yet another U.S. Pat. No. 6,971,238 was issued to Walker on Dec. 6, 2005. Another was issued to Boulter on Nov. 11, 2008 as U.S. Pat. No. 7,448,600 and still yet another was published on Nov. 20, 2008 to Haslem et al. as U.S. Patent Application No. 2008/0283623.

Another patent application was published to Lakatos et al. on Aug. 13, 2009 as U.S. Patent Application No. 2009/0199972. Yet another U.S. Pat. No. 7,604,710 was issued to Haslem et al. on U.S. Pat. No. 7,604,710. Another was issued to Rodriquez on Feb. 16, 1992 as Spanish Patent No. ES2024097 and still yet another was issued on Aug. 16, 2001 to Sanchez as Spanish Patent No. ES2157798.

### U.S. Pat. No. 1,233,119

### Inventor: Lee H. Parker

### Issued: Jul. 10, 1917

A spraying system for cooling ponds and the like having a pipe line provided with spray nozzles arranged in sets, the outer nozzles of each set being substantially the same distance from each other as they are from the adjacent nozzles of the next adjacent sets.

### U.S. Pat. No. 4,449,849

### Inventor: Spencer C. Horn et al.

### Issued: May 22, 1984

A method of removing water from earthen pits such as the earthen pits commonly used in the drilling of oil and gas wells for containing reserve drilling fluid is provided. By the method, a plurality of spray nozzles are placed around the periphery of the pit, and the nozzles are directed towards the center of the pit. Water from the pit is pumped through the nozzles whereby the water is sprayed towards the center of the pit and removed therefrom by the evaporation thereof.

### U.S. Pat. No. 4,762,276

### Inventor: H. Clyde Foust

### Issued: Aug. 9, 1988

A device for increasing the evaporation of liquid from mud pits is disclosed having an elongated collection tank suspended from flotation means for holding a quantity of the liquid. A plurality of riser pipes extending from the collection tank to the surface of the liquid, each of the riser pipes having a nozzle connected to the end thereof capable of converting the liquid into a hollow, conical spray having ultrafine droplets.

### U.S. Pat. No. 6,190,498

### Inventor: Kim Blagborne

### Issued: Feb. 20, 2001

A relatively simple portable evaporator for quickly evaporating large volumes of water includes a stand with adjustable legs, a frame carrying a tubular housing and a motor rotatably mounted on the stand for rotation around a vertical axis, a fan in the housing driven by the motor, a nozzle rotatably mounted on one end of the housing for directing air from the fan upwardly and outwardly from the housing, and a manifold carrying a plurality of jets for receiving water from a tailings pond or other source and spraying the water into a stream of air exiting the nozzle for expediting evaporation.

### U.S. Pat. No. 6,802,360

### Inventor: Ralph J. Schmidt

### Issued: Oct. 12, 2004

A floating heat exchanger for pond liquid and a method of evaporating water from the pond liquid that utilizes a mass of pipes that are floated at or just below the surface of the pond liquid with one end of the pipes being connected to an inlet manifold and the opposite end of the pipes connected to an outlet manifold. The pipes and manifolds are part of a heated closed loop heat transfer fluid system. The pond liquid is raised in temperature which facilitates the evaporation of water and the concentration of dissolved or suspended solids within the pond liquid.

### U.S. Pat. No. 6,971,238

### Inventor: Weldon Eugene Walker

### Issued: Dec. 6, 2005

A method and apparatus useful for disposing of the high volumes of produced water associated with coal bed methane natural gas wells. The method taught is to create steam from the produced water and vent the steam into the atmosphere. The apparatus taught utilizes the available field gas to produce heat for enhancing evaporation and drive a steam turbine generator to produce electrical power.

### U.S. Pat. No. 7,448,600

### Inventor: Roger P. Boulter

### Issued: Nov. 11, 2008

A working pontoon raft has frame that supports a plurality of high speed evaporator fans. An on board pump draws wastewater from under the raft and feeds it to the fans. Large amounts of wastewater from industrial reservoirs, such as oil drilling reservoirs, are evaporated into the air in an environmentally friendly manner. Power is supplied to the raft via hydraulic lines. A land base generator supplies the hydraulic power. The entire system fits on a custom trailer.

### U.S. Patent Application Number 2008/0283623

### Inventor: Darrin N. Haslem et al.

### Published: Nov. 20, 2008

A water evaporation system and method for disposing of excess water left over from oil or gas drilling, fracturing, and production operations and from other wastewater producing operations. The system comprises a pumping system for pumping the wastewater from a pond through a filtration system and then to one or more nozzle arrays attached to cables suspended over the pond.

### U.S. Patent Application Number 2009/0199972

### Inventor: Janos L. Lakatos et al.

### Issued: Aug. 13, 2009

A fluid evaporation system includes a housing bounding a fluid reservoir and an air flow path that is disposed over top of the fluid reservoir. The housing has an inlet opening and a spaced apart outlet opening that both provide communication between the outside environment and the air flow path. A fan is positioned to draw the air out of the air flow path through the outlet opening. A baffle projects into the air flow path at a location between inlet opening and the outlet opening so as to constrict the area of the air flow path thereat. A plurality of spray nozzles are positioned within air flow path between the baffle and the first end of the housing. A pump is configured to draw fluid from the reservoir and deliver it to the plurality of spray nozzles.

### U.S. Pat. No. 7,604,710

### Inventor: David J. Haslem et al.

### Issued: Oct. 20, 2009

A floating water evaporation system for use in disposing of excess water from oil and gas drilling operations is provided. One or more nozzle arrays float on the surface of a wastewater pond a distance away from the pond shoreline. Each nozzle array includes a series of upright risers that extend above a water reservoir tank. Spray nozzles are mounted on each riser. The water reservoir tank is mounted between floating pontoons that elevate the nozzles a distance above the surface of the pond. Water from the pond is pumped through the nozzles to create a patterned spray of small evaporable droplets.

### Spain Patent Number ES2024097

### Inventor: Jose Manual Corral Rodriguez

### Issued: Feb. 16, 1992

System composed of various machines which float in the reservoir which it is desired to dry out, and they are anchored to the banks of the reservoir so that they follow variations in level, but without horizontal displacement. The machines consist of a vertical wind turbine 3 which moves a pump provided with rotary tubes 4 at whose ends their are spraying devices 5. When the system rotates, water exits, sprayed by the spraying devices, with the result that evaporation takes place more rapidly than would be the case naturally, owing to the increase in aqueous surface exposed to the air and to the action of the wind. It may be applied to the drying-out of any type of pool containing waste water.

### Spain Patent Number ES2157798

### Inventor: Antonio Rodriguez Sanchez

### Published: Aug. 16, 2001

Module for the forced evaporation of liquids from floats and the like. The module is equipped with a superficial aspirator (1) through which a pump (3) takes the residual liquid concerned, for instance bleaches or brine, from the upper layers of the float containing them, pumping it to an upper annular atomiser (4) which has a set of nebulizers (5) which fragment the liquid into small particles with a high kinetic energy and in the heart of the atomiser (4) a blast of dry air generate an air current whose molecules hit the liquid particles, caused a rapid evaporation of the latter. The module described can be placed in the centre of the actual float, at any point on the same, with the use of a float (8) easily fitted to its supporting structure (6) or it can be located outside the float on the ground, in which case it will not have a float (8). The ventilator (9) is assisted by a suction tube (10) which can intake ambient air or be connected to any generating source of hot, dry air.

While these evaporators may be suitable for the purposes for which they were designed, they would not be as suitable for the purposes of the present invention, as hereinafter described.

### SUMMARY OF THE PRESENT INVENTION

A water evaporation system for use in disposing of wastewater in the mining, manufacturing, oil & gas and food processing industries. One or more forced air thermal evaporation units consists of a nozzle system that floats on a water source or sits away from water source. Each pontoon based nozzle system has a series of nozzles that sit on a riser that is attached to inlet air distribution header and the land based nozzle system has two nozzles attached to the air distribution header. Air is pumped from air compressor at 50 psi to 200 psi and at 50 degrees F. to 195 degrees F. to a primary heat exchanger. The heated air leaves the primary heat exchanger through high temperature hoses at 350 degrees F. to 460 degrees F. and enters the air distribution header. (Pontoon Based)The air leaves the air distribution header through a series of risers through a ⅛ inch hole in the riser (eductor) and into the bottom of the air/water mixing nozzles where the air is mixed with inlet water and disbursed through a spiral cone nozzle into the atmosphere at 28 cubic feet per minute to 50 cubic feet per minute. (Land Based) The air leaves the air distribution header and enters one of two eductors at 375 cubic feet per minute per eductor.

The primary heat exchanger utilizes the waste heat off of the air compressor exhaust to heat the air from the air compressor going to the nozzle system.

The water entering the air/water mixing nozzles (eductors) is siphoned or pumped in at a rate of 4 gallons per minute per nozzle on the nozzle system (pontoon based) or at a rate of 21 gallons per minute per nozzle on land based system. The water is siphoned or pumped through (2)-⅜ inch siphon tubes per nozzle (pontoon based) or through 2-2 inch siphon tubes per nozzle (land based) and enters the side of the nozzle where the water is mixed with the air from the primary heat exchangers to form a water vapor which is disbursed through the spiral cone nozzle into the atmosphere.

The system allows for a greater evaporation rate by utilizing waste heat to form a water/steam vapor to enter the atmosphere. This provides a 65 to 80% greater efficiency over conventional evaporation systems.

This system reduces the environmental impact due to the fact that there are no large water droplets for the wind to carry outside containment areas since the water leaving the spiral cones are a fine heated vapor.

This system enhances the ability to evaporate in cold and humid conditions due to the fact that the water and air are heated using the waste heat source. The system is modular so that is can be customized for size and evaporation needs at each site.

A primary object of the present invention is to provide an evaporation system for disposing of wastewater in the mining, manufacturing, oil & gas and food processing industries.

Another object of the present invention is to provide an evaporation system using waste heat for accelerating evaporation of wastewater.

Yet another object of the present invention is to provide an evaporation system using a land based or pontoon based nozzle system.

Additional objects of the present invention will appear as the description proceeds.

The present invention overcomes the shortcomings of the prior art by providing a water evaporation system for use in disposing of wastewater in the mining, manufacturing, oil and gas and food processing industries. Depicted in the application drawings are dimensioned embodiments for illustrative purposes only of the components of the present invention and should not be taken as the only possible sizes envisioned by the instant invention.

The foregoing and other objects and advantages will appear from the description to follow. In the description reference is made to the accompanying drawings, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawings, like reference characters designate the same or similar parts throughout the several views.

The following detailed description is, therefore, not to be taken in a limiting sense, and the scope of the present invention is best defined by the appended claims.

### BRIEF DESCRIPTION OF THE DRAWING FIGURES

In order that the invention may be more fully understood, it will now be described, by way of example, with reference to the accompanying drawing in which:

FIG. 1 is a flow diagram of both embodiments of the evaporation system;

FIG. 2 is a top view of the primary heat exchanger;

FIG. 3 is a side view of the primary heat exchanger;

FIG. 4 is a top view of the pontoon nozzle system;

FIG. 5 is a side view of the pontoon nozzle system;

FIG. 6 is a side view of the air/water mixing nozzles;

FIG. 7 is a top view of the land based nozzle system; and

FIG. 8 is a side view of the land based nozzle system.

### DESCRIPTION OF THE REFERENCED NUMERALS

Turning now descriptively to the drawings, in which similar reference characters denote similar elements throughout the several views, the figures illustrate the Competitive Model Car Game of the present invention. With regard to the reference numerals used, the following numbering is used throughout the various drawing figures.

10 Forced Air Thermal Evaporator

12 waste exhaust heat

14 outgoing air

16 air compressor

18 (primary) air heat exchanger

20 distribution header

22 spiral cone nozzles

24 pontoons

26 eductor

28 discharge pipe

30 housing

32 waste heat inlet

34 hot air outlet

36 waste heat outlet

38 cold air inlet

40 connector pipe

42 air/water mix nozzles

44 hot air inlet

46 cross members

48 siphon tube

50 ports

52 pipe nipple

54 conical end of 52

56 block

58 top outlet of 56

60 spray nozzle

62 aluminum barrel

64 stand

### DETAILED DESCRIPTION OF THE PREFERRED EMBODIMENT

The following discussion describes in detail one embodiment of the invention (and several variations of that embodiment). This discussion should not be construed, however, as limiting the invention to those particular embodiments, practitioners skilled in the art will recognize numerous other embodiments as well. For definition of the complete scope of the invention, the reader is directed to appended claims.

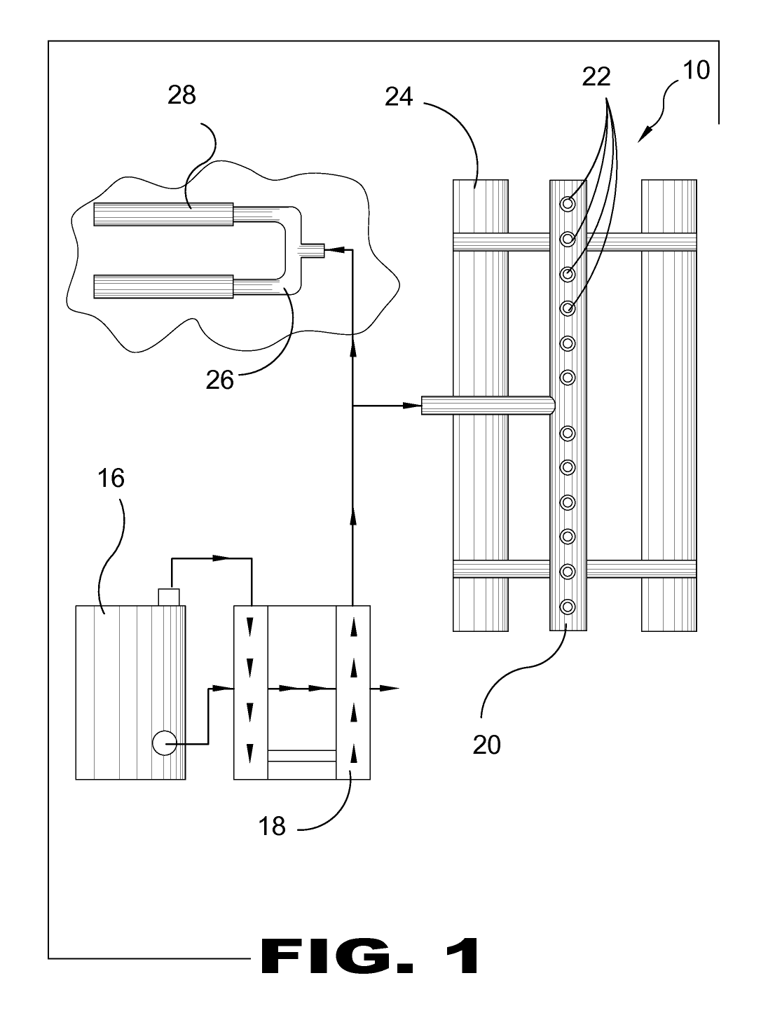

FIG. 1 is a flow diagram of both embodiments of the evaporation system 10. The present invention is a land based and pontoon based forced air thermal evaporator 10. Shown is the waste exhaust heat 12 used to heat the outgoing air 14 from the air compressor 16 through an air to air heat exchanger 18 to the distribution header 20 in which the air/water mixture is disbursed into the atmosphere through the spiral cone nozzles 22. Also shown are the pontoons 24, the eductor 26 and the discharge pipe 28.

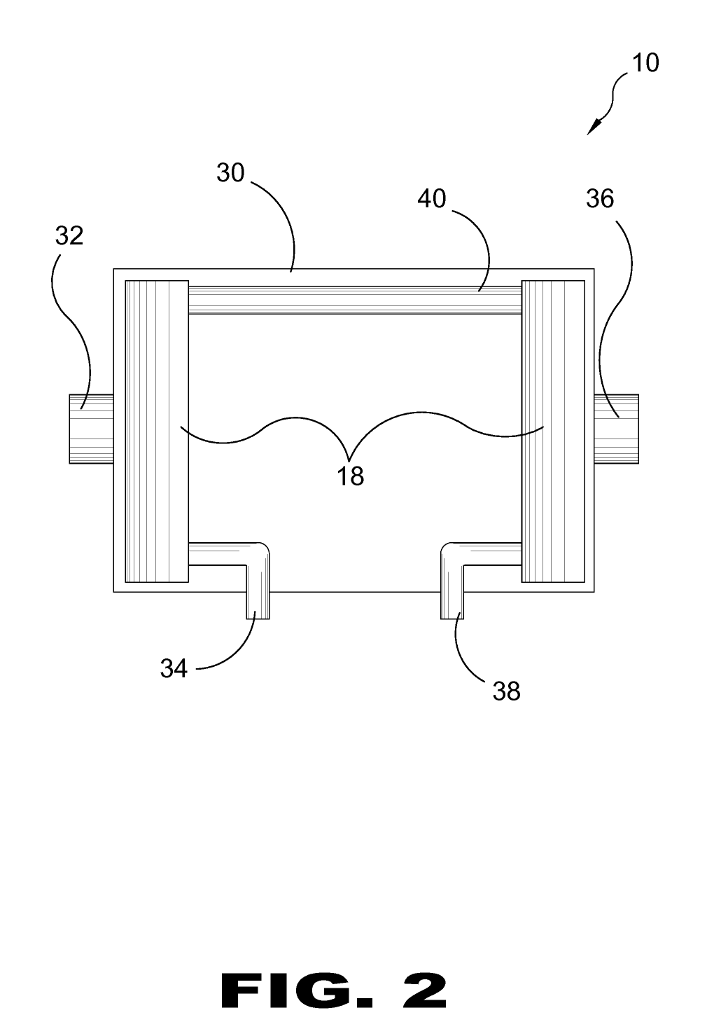

FIG. 2 is a top view of the primary heat exchanger 18 of the present invention 10. The heat exchangers 18 are contained in a housing 30 with one having a waste heat inlet 32 and a hot air outlet 34 and the other having a waste heat outlet 36 and a cold air inlet 38. The heat exchangers communicate via a connector pipe 40. Preferably the primary heat exchanger comprises an ⅛ inch thick aluminum shell and 2-3 inch aluminum air to air exchangers, where the waste exhaust heat temperatures of 450 degrees to 600 degrees is transferred to the incoming air. The incoming air temperatures range from 50 degrees to 190 degrees and the outgoing air temperature from the primary heat exchanger is 350 to 460 degrees f.

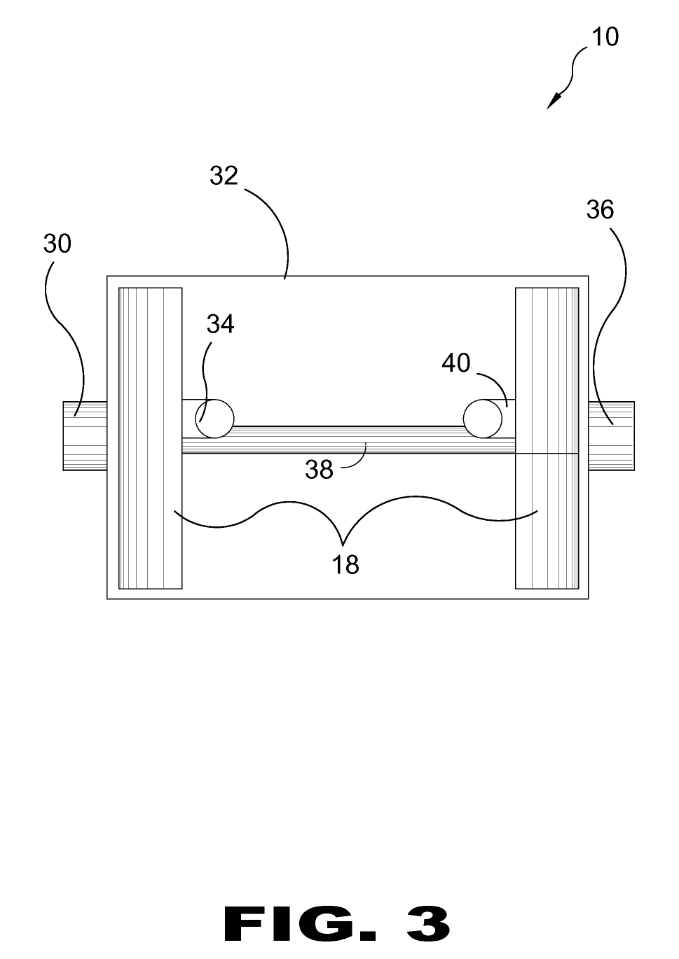

FIG. 3 is a side view of the primary heat exchanger 18 of the present invention 10. Preferably the primary heat exchanger 18 comprises an ⅛ inch thick aluminum shell and 2-3 inch aluminum air to air exchangers, where the waste exhaust heat temperatures of 450 degrees to 600 degrees is transferred to the incoming air. The incoming air temperatures range from 50 degrees to 190 degrees and the outgoing air temperature from the primary heat exchanger is 350 to 460 degrees F. The heat exchanger 18 is contained in a housing 30 with one having a waste heat inlet 32 and a hot air outlet 34 and the other having a waste heat outlet 36 and a cold air inlet 38. The heat exchangers communicate via a connector pipe 40.

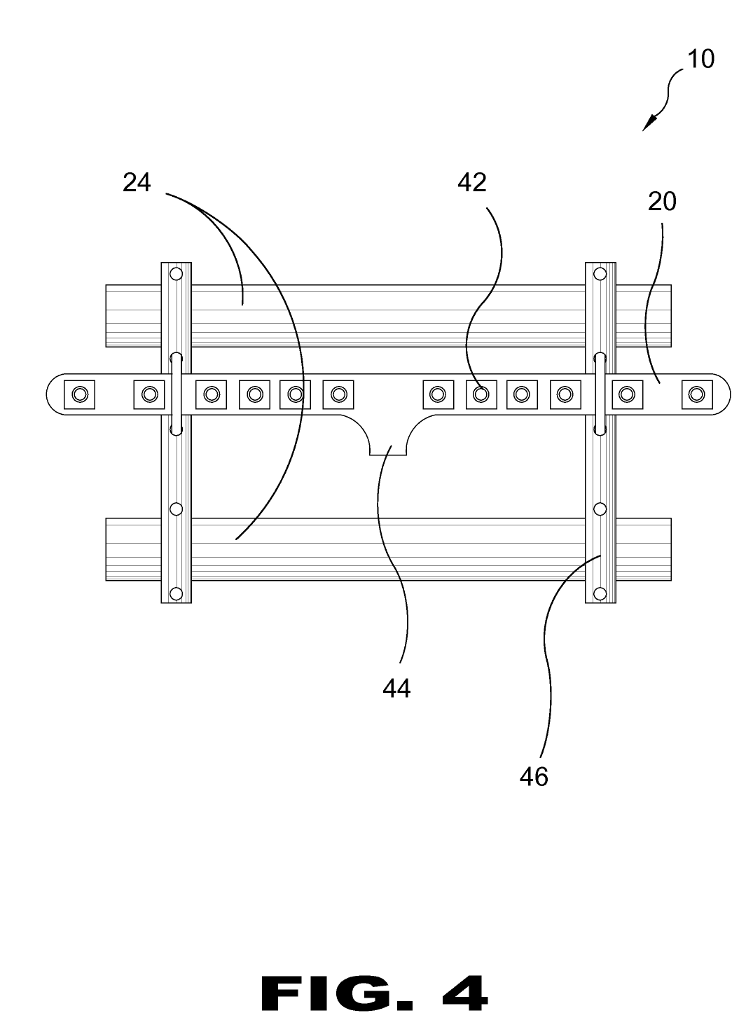

FIG. 4 is a top view of the pontoon nozzle system 10. Shown is the pontoon 24 based nozzle system, which includes the air distribution headers 20, flotation devices 24 and the air/water mix nozzles 42. Preferably the water travels through ⅜″ poly-tubing and enters the side of the air/water mixing nozzles 42, while the hot air from the heat exchanger enters through a hot air inlet 44. The air distribution header 20 is typically 3″ carbon steel pipe with 1 (one) ¾″ outlet pipe per nozzle for a total of 12 outlet pipes. The ¾ inch outside diameter outlet pipe has a ⅛ inch inside diameter through the center of the pipe. The outlet pipe to the nozzle is raised above the air distribution header 20 between 2 and 4 inches, which the air/water mixing nozzle 42 is threaded onto. The air/water mixing nozzle 42 with the ¾ inch riser forms a type of eductor. The typical floatation devices are pontoons 24 made of 6″ PVC piping with galvanized 1½″ cross members 46 U-bolted to the PVC piping. The air distribution header 20 is then U-bolted to the cross members 46.

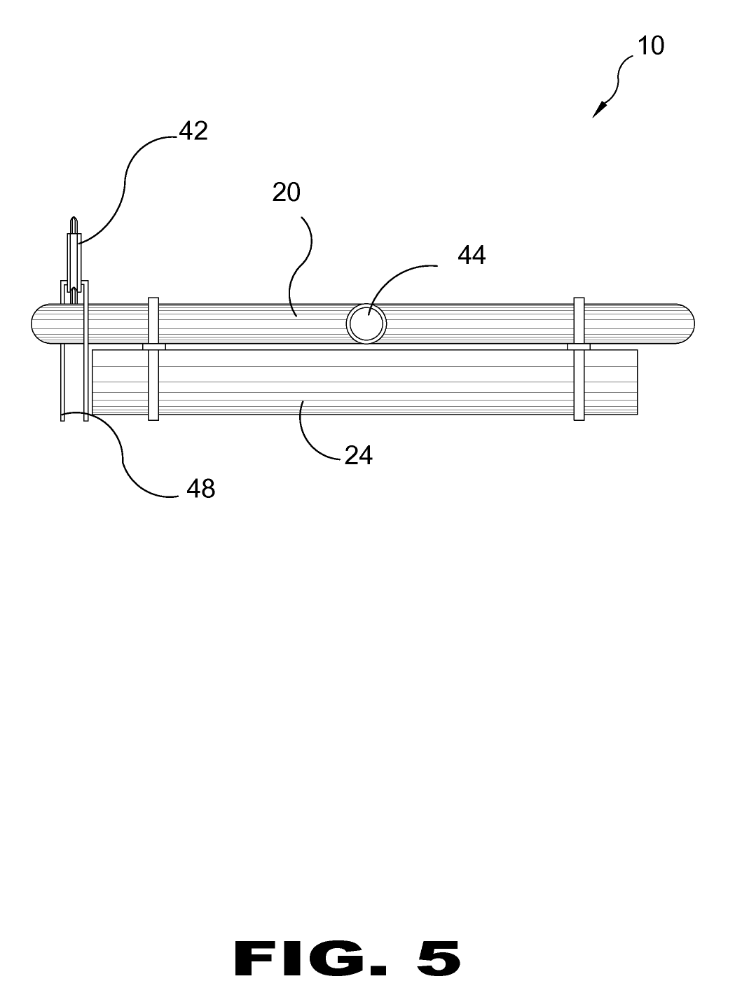

FIG. 5 is a side view of the pontoon nozzle system of the present invention 10. Shown is the pontoon 24 based nozzle system, which includes the air distribution headers 20, flotation devices and the nozzles. Preferably the water travels through ⅜″ poly-tubing and enters the side of the air/water mixing nozzles 42. The air distribution header 20 is typically 3″ carbon steel pipe with 1 (one) ¾″ outlet pipe per nozzle for a total of 12 outlet pipes. The ¾ inch outside diameter outlet pipe has a ⅛ inch inside diameter through the center of the pipe. The outlet pipe to the nozzle 42 is raised above the air distribution header 20 between 2 and 4 inches which the air/water mixing nozzle 42 is threaded onto. The air/water mixing nozzle 42 with the ¾ inch riser forms a type of eductor. The typical floatation devices 24 are made of 6″ PVC piping with galvanized 1½″ cross members 46 U-bolted to the PVC piping. The air distribution header 20 is then U-bolted to the cross members 46. Also shown is a siphon tube 48 adapted to extend into the body of waste water below the pontoons 24 such that waste water is siphoned through the siphon tube 48 into the mixing nozzles 42 when the compressor is engaged.

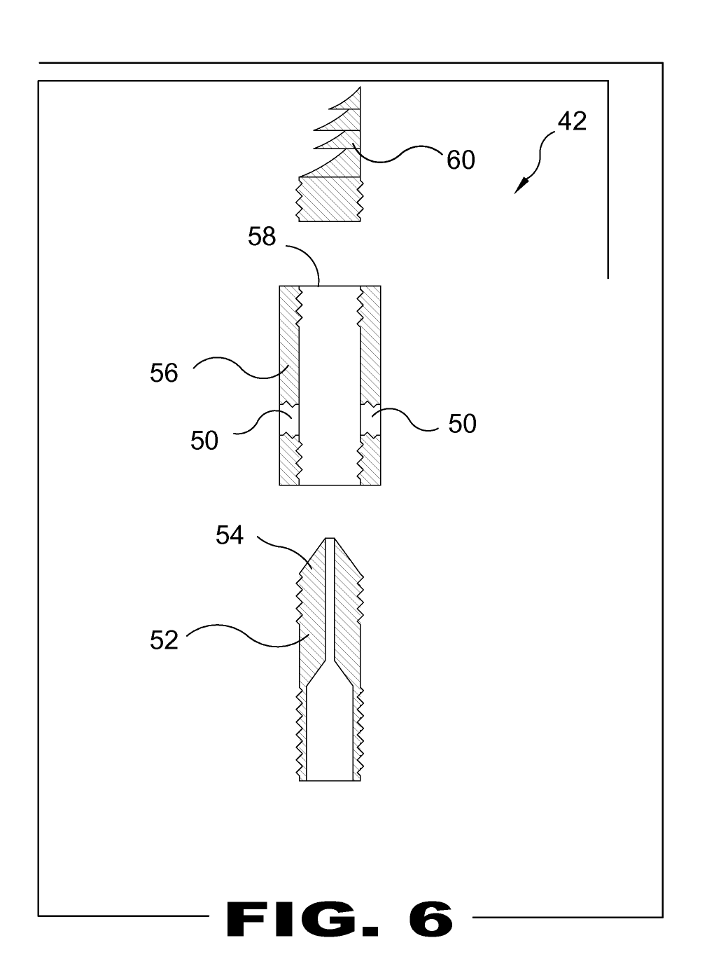

FIG. 6 is a side view of the air/water mixing nozzles 42. Shown is a side view of the air/water mixing nozzles 42 which attach to the air distribution header by ¾″ threads in the bottom of the nozzle and to the water siphon tubes through ⅜″ ports 50. The air/water mixing nozzle 42 starts with a ¾ inch pipe nipple 52 that is 4 inches long. The nipple 52 has ¾ inch male NPT pipe threads on each end. One end has a conical end 54 with a ⅛ inch hole through the center. The conical end 54 threads into a 1½ inch square aluminum block 56. The 1½ inch aluminum block 56 has ¾ inch diameter hole that runs the length of the block with ¾ inch female NPT threads at each end of the block 56. On two opposing sides of the block 56 is a ⅜ inch port 50 with female NPT threads. This port 50 is located approx. 2½ inches above the bottom of the block 56. The bottom of the block 56 threads onto the conical end 54 of the nipple 52. Threaded into the top ¾ inch outlet 58 is a ¾ inch brass spiral spray nozzle 60.

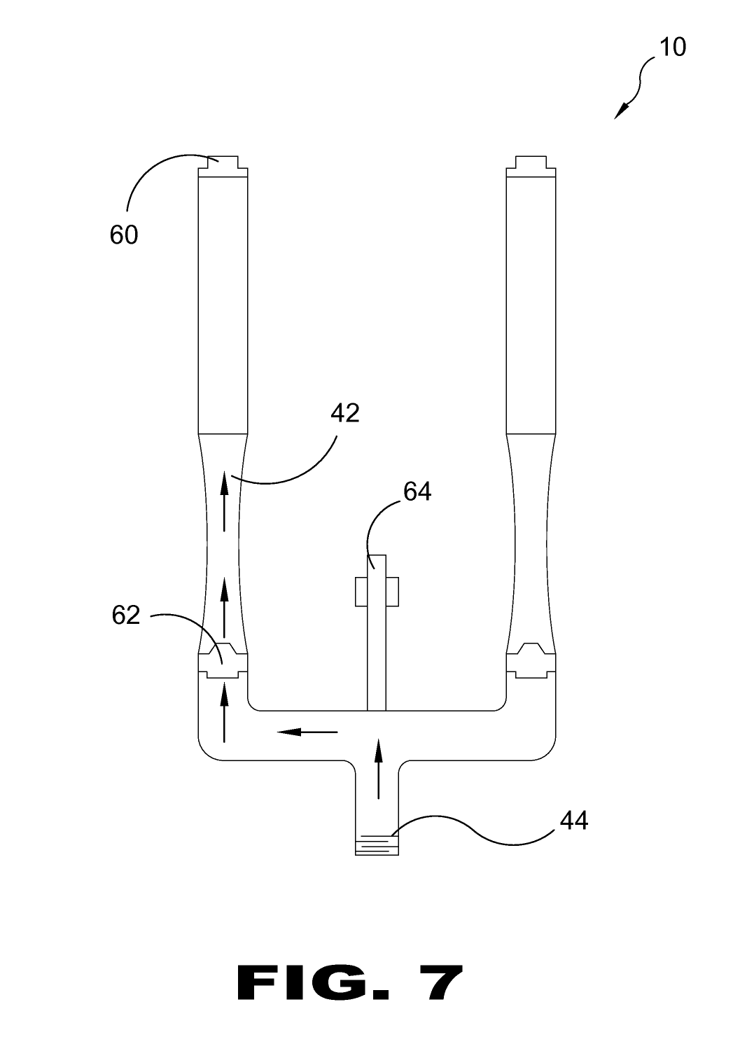

FIG. 7 is a top view of the land based nozzle system of the present invention. Shown the land based nozzle system which includes the air distribution header 20, the 2 inch air/water mixing barrels 42 (eductors), the 2 inch aluminum barrels 62 and the 1½ spray nozzles 60. The 750 cubic feet of heated air from the primary heat exchanger enters a 2 inch threaded male NPT fitting 44. The air flow is split into 2 (two) 2 inch eductors. The air flow draws water into the eductor through a 2 inch port 50. The water is then mixed with the heated air in the air/water mixing barrel 42. The air/water vapor travels through a 2 inch aluminum barrel 62 and then through a 1½ inch fogging spray nozzle 60 into the atmosphere. A stand 64 supports the distribution header 20 on a solid ground surface.

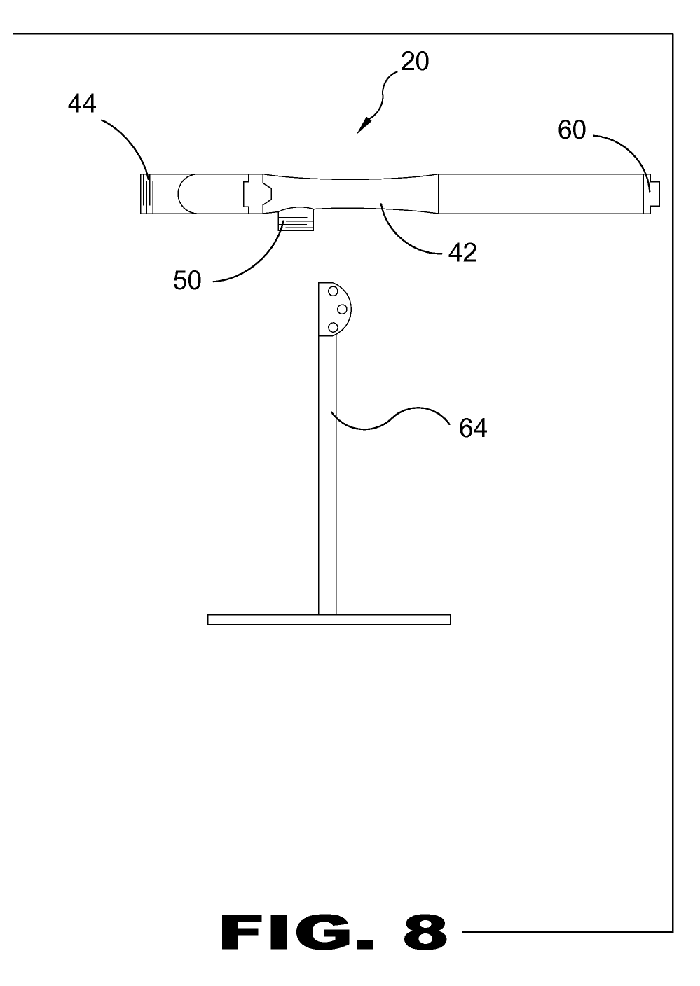

FIG. 8 is a side view of the land based nozzle system. Shown the land based nozzle system which includes the air distribution header 20, the 2 inch air/water mixing barrels 42 (eductors), the 2 inch aluminum barrels 62 and the 1½ spray nozzles 60. The 750 cubic feet of heated air from the primary heat exchanger enters a 2 inch threaded male NPT fitting 44. The air flow is split into 2 (two)-2 inch eductors. The air flow draws water into the eductor through a 2 inch port 50. The water is then mixed with the heated air in the air/water mixing barrel 42. The air/water vapor travels through a 2 inch aluminum barrel 62 and then through a 1½ inch fogging spray nozzle 60 into the atmosphere. A stand 64 supports the distribution header 20 on a solid ground surface.

It will be understood that each of the elements described above, or two or more together may also find a useful application in other types of methods differing from the type described above.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and desired to be protected by Letters Patent is set forth in the appended claims:

1. A forced air thermal evaporator system for evaporating waste water with waste heat comprising:
a) an air heat exchanger having a waste heat inlet, a waste heat outlet, a cold air inlet and a hot air outlet;
b) a compressor connected with said cold air inlet to force air into said cold air inlet; and
c) a distribution header having a hot air inlet connected with said hot air outlet, a waste water inlet connected to a waste water source, and a plurality of air/water mixing nozzles connected with said hot air inlet and said waste water inlet.

2. The forced air thermal evaporator system according to claim 1, wherein said distribution header is adapted to float on a body of waste water.

3. The forced air thermal evaporator system according to claim 2, further comprising a plurality of pontoons affixed to said distribution header.

4. The forced air thermal evaporator system according to claim 3, further comprising a plurality of cross-members, wherein said pontoons are affixed to said cross-members and said distribution header is affixed to said cross-members.

5. The forced air thermal evaporator system according to claim 4, wherein said waste water inlet comprises a siphon tube adapted to extend into a body of waste water below said pontoons such that waste water is siphoned through said siphon tube into said mixing nozzles when said compressor is engaged.

6. The forced air thermal evaporator system according to claim 5, wherein each of said mixing nozzles comprises:
a) a pipe nipple having opposite distal ends, a lower end adapted to connect with said distribution header and an upper, conical end;
b) a hollow block having a lower end adapted to threadedly engage said upper conical end of said pipe nipple, a threaded upper end, and a port extending through a side of said block, said port adapted to matingly engage said siphon tube; and
c) a spray nozzle adapted to threadedly engage said threaded upper end of said block.

7. The forced air thermal evaporator system according to claim 6, wherein said port extends through opposing sides of said block and said spray nozzle is a spiral spray nozzle.

8. The forced air thermal evaporator system according to claim 7, wherein said block is formed of aluminum and said spiral spray nozzle is formed of brass.

9. The forced air thermal evaporator system according to claim 1, wherein each of said mixing nozzles comprises:
a) a pipe nipple having opposite distal ends, a lower end adapted to connect with said distribution header and an upper, conical end;
b) a hollow block having a lower end adapted to threadedly engage said upper conical end of said pipe nipple, a threaded upper end, and a port extending through a side of said block, said port adapted to matingly engage said siphon tube; and
c) a spray nozzle adapted to threadedly engage said threaded upper end of said block.

10. The forced air thermal evaporator system according to claim 1, further comprising a stand adapted to support said distribution header on a solid surface.

11. The forced air thermal evaporator system according to claim 10, wherein said air/water mixing nozzles comprise a plurality of eductors.

12. The forced air thermal evaporator system according to claim 11, wherein each of said eductors comprises a spray nozzle, a mixing barrel, and a port extending through a side of said eductor, said port adapted to matingly engage said waste water inlet.

13. The forced air thermal evaporator system according to claim 12, wherein each said port extends through opposing sides of each said eductor.

14. The forced air thermal evaporator system according to claim 13, wherein said eductor is formed of aluminum.

15. A method of evaporating waste water with waste heat comprising the steps:
a) providing a forced air thermal evaporator system having an air heat exchanger with: a waste heat inlet, a waste heat outlet, a cold air inlet and a hot air outlet; a compressor connected with said cold air inlet to force air into said cold air inlet; and a distribution header having a hot air inlet connected with said hot air outlet, a waste water inlet connected to a waste water source, and a plurality of air/water mixing nozzles connected with said hot air inlet and said waste water inlet;
b) connecting said waste heat inlet to a source of waste heat;
c) connecting said waste water inlet with a source of waste water; and
d) engaging said compressor to force air through said heat exchanger and into said distribution header.

16. The method according to claim 15, wherein said compressor causes air flow through said distribution header and said air flow draws waste water through said waste water inlet to mix with said air flow in said mixing nozzles.

17. The method according to claim 16, further comprising the steps:
a) floating said distribution header on a body of waste water;
b) providing a siphon tube as said waste water inlet, said siphon tube adapted to extend into a body of waste water below said distribution header such that waste water is siphoned through said siphon tube into said mixing nozzles when said compressor is engaged.

18. The method according to claim 17, wherein each of said mixing nozzles comprises:
a) a pipe nipple having opposite distal ends, a lower end adapted to connect with said distribution header and an upper, conical end;
b) a hollow block having a lower end adapted to threadedly engage said upper conical end of said pipe nipple, a threaded upper end, and a port extending through a side of said block, said port adapted to matingly engage said siphon tube; and
c) a spray nozzle adapted to threadedly engage said threaded upper end of said block.

19. The method according to claim 15, wherein further comprising the step of supporting said distribution header on a solid surface with a stand affixed to said distribution header.

20. The method according to claim 19, wherein said air/water mixing nozzles comprise a plurality of eductors each having a spray nozzle, a mixing barrel, and a port extending through a side of said eductor, said port adapted to matingly engage said waste water inlet.
